(19) United States
(12) Patent Application Publication
(10) Pub. No.: US 2012/0199570 A1
(43) Pub. Date: Aug. 9, 2012

(54) HEATING SYSTEM WITH IMPROVED EFFICIENCY

(76) Inventor: Thomas Lynn HAMAKER, Harrisburg, PA (US)

(21) Appl. No.: 13/020,606

(22) Filed: Feb. 3, 2011

(51) Int. Cl. B60L 1/02

(52) U.S. Cl. 219/208

(57) ABSTRACT

An apparatus and method for heating a defined space uses an engine to generate the heat required. The heating system includes a tank for heating liquid. A liquid coolant system has conduits which extend between the engine and the tank. A first respective conduit supplies coolant liquid from the tank to the engine and a second respective conduit supplies liquid which has been drawn through the engine and heated to the tank. An exhaust transfer system has an exhaust conduit which extends from the engine to the tank. A heating element is located in the tank to provide a supplemental heat source. Heating conduits extend from the tank to the space to be heated. The liquid coolant system, the exhaust transfer system and the heating element cooperate to heat the liquid in the tank quickly, thereby minimizing run time of the engine and increasing the efficiency of the heating system.

### FIELD OF THE INVENTION

The present invention is directed to a heating system which generates heat while reducing the amount of fuel consumed. In particular, a heating system which utilizes an engine and a generator to heat a liquid used to heat a defined space.

### BACKGROUND OF THE INVENTION

A household furnace is a major appliance that is permanently installed to provide heat to an interior space through intermediary fluid movement, which may be air, steam, or hot water. The most common fuel source for modern furnaces in the United States is natural gas; other common fuel sources include LPG (liquefied petroleum gas), fuel oil, coal or wood. In some cases electrical resistance heating is used as the source of heat, especially where the cost of electricity is low.

Combustion furnaces always need to be vented to the outside. Traditionally, this was through a chimney, which tends to expel a great deal of heat along with the exhaust. Modern high-efficiency furnaces can be 98% efficient, when measured by the Energy Star rating system which measures Annual Fuel Utilization Efficiency, and operate without a chimney. The small amount of waste gas and heat are mechanically ventilated through a small tube through the side or roof of the house.

“High-efficiency” in this sense may be misleading, because furnace efficiency is typically expressed as a “first-law” efficiency, whereas the energy efficiency of a typical furnace is much lower than the first-law thermal efficiency. However, as the vast majority of consumers (as well as many government regulators) are unfamiliar with exergy efficiency, Carnot efficiency, and the second law of thermodynamics, the use of first-law efficiencies to rate furnaces, while misleading, is well-entrenched.

The furnace transfers heat to the living space of the building through an intermediary distribution system. If the distribution is through hot water (or other fluid) or through steam, then the furnace is more commonly termed a boiler.

Prior art forced-air/boiler furnaces used in residential and commercial buildings or for enclosed portions thereof are relatively large in size, have poor emission levels, have low thermal efficiency, often require large exhaust systems such as a chimney and are therefore impractical for a number of applications.

The low thermal efficiency of prior art furnaces based on the usable fuel gas, oil or other combustible material is well documented. Most prior art furnaces have efficiency levels of less than 75% and require large exhaust systems such as a chimney to remove the undesirable products of combustion to the outside atmosphere. Chimneys often exit the products of combustion at temperatures well above 300 degrees Fahrenheit. The more recent “High Efficiency” designs of furnaces have addressed this issue to the extent practical by utilizing existing technology. These high efficiency units employ a primary heat exchanger and a secondary exchanger employing a draw fan motor to extract the products of combustion, and thereby do not require a chimney. In place of the chimney, the high efficiency furnaces have an exhaust pipe of between 2 inches and 6 inches in diameter to dispose of the toxic products of combustion to the outside atmosphere. These high efficiency furnaces of newer design have thermal efficiency of up to 97% (under the Energy Star Rating System) but they do not address all of the thermal efficiency issues. However, as previously stated, “High-efficiency” ratings can be misleading, as they are determined based on calculations of the ENERGY STAR rating system which uses the Annual Fuel Utilization Efficiency measures and the test procedures found in 10 Code of Federal Regulations part 430, Appendix N. Therefore, the “High-efficiency” ratings of the prior systems can be significantly overstated in terms of real efficiency.

It would be beneficial to provide a heating system in which the true efficiency of the system was increased over the prior art. In so doing, it may be necessary to depart from the typical furnace arrangement which has burners, heat exchanger, draft inducer, and venting.

### SUMMARY OF THE INVENTION

An exemplary embodiment of a heating system for heating a defined space uses an engine to generate the heat required. The heating system includes a tank for heating liquid enclosed in the heating system. A liquid coolant system has conduits which extend between the engine and the tank. A first respective conduit supplies coolant liquid from the tank to the engine and a second respective conduit supplies liquid which has been drawn through the engine and heated to the tank. An exhaust transfer system has an exhaust conduit which extends from the engine to the tank. The exhaust conduit conducts heated exhaust from the engine to the tank and is connected to a heat exchanger to facilitate an exchange of heat from the heated exhaust to the liquid in the tank. A heating element is located in the tank to provide a supplemental heat source. Heating conduits extend from the tank to the space to be heated. The liquid coolant system, the exhaust transfer system and the heating element cooperate to heat the liquid in the tank quickly, thereby minimizing run time of the engine and increasing the efficiency of the heating system.

An exemplary embodiment of a heating system for heating a defined space has an engine, generator and tank. The generator is mechanically attached to the engine and is rotated to produce an electrical current when the engine is engaged. The tank is provided to heat liquid enclosed in the heating system. A liquid coolant system has conduits which extend between the engine and the tank, with a first respective conduit supplying coolant liquid from the tank to the engine and a second respective conduit supplying liquid which has been drawn through the engine and heated to the tank. An exhaust transfer system has an exhaust conduit which extends from the engine to the tank to conduct heated exhaust from the engine to the tank. The exhaust conduit is connected to a heat exchanger to facilitate an exchange of heat from the heated exhaust to the liquid in the tank. A heating element is located in the tank. The heating element receives the electrical current from the generator and converts the electrical current to a supplemental heat source for the liquid. Heating conduits extend between the tank and the space to be heated. The liquid coolant system, the exhaust transfer system and the heating element are all driven from the operation of the engine, thereby increasing the efficiency of the heating system.

An exemplary method for heating a defined space includes the steps of: engaging an engine; generating an electrical current when the engine is engaged; cooling the engine with a liquid coolant system, the liquid coolant system having conduits which extend between the engine and a tank, a first respective conduit supplying coolant liquid from the tank to the engine; heating the coolant liquid in the engine and returning the heated coolant liquid through a second respective conduit to the tank to heat the liquid in the tank; transferring heated exhaust through an exhaust conduit which extends from the engine to the tank to heat the liquid in the tank; activating a heating element located in the tank by using the electrical current generated, the heating element providing supplemental heat to heat the liquid in the tank; drawing the heated liquid through a heating conduit to heat the defined space; whereby the liquid in the tank is heated in an energy efficient manner.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a diagrammatic view of an exemplary embodiment of a heating system for a defined space.

FIG. 2 is a diagrammatic view of an engine and a generator of the exemplary embodiment of the heating system housed in a cabinet.

FIG. 3 is a diagrammatic view of an engine and a generator of the exemplary embodiment of the heating system housed in a first alternate cabinet.

FIG. 4 is a diagrammatic view of an engine and a generator of the exemplary embodiment of the heating system housed in a second alternate cabinet.

FIG. 5 is a diagrammatic view of an alternate exemplary embodiment of the heating system, with various components shown in phantom within a tank enclosure.

### DETAILED DESCRIPTION OF THE INVENTION

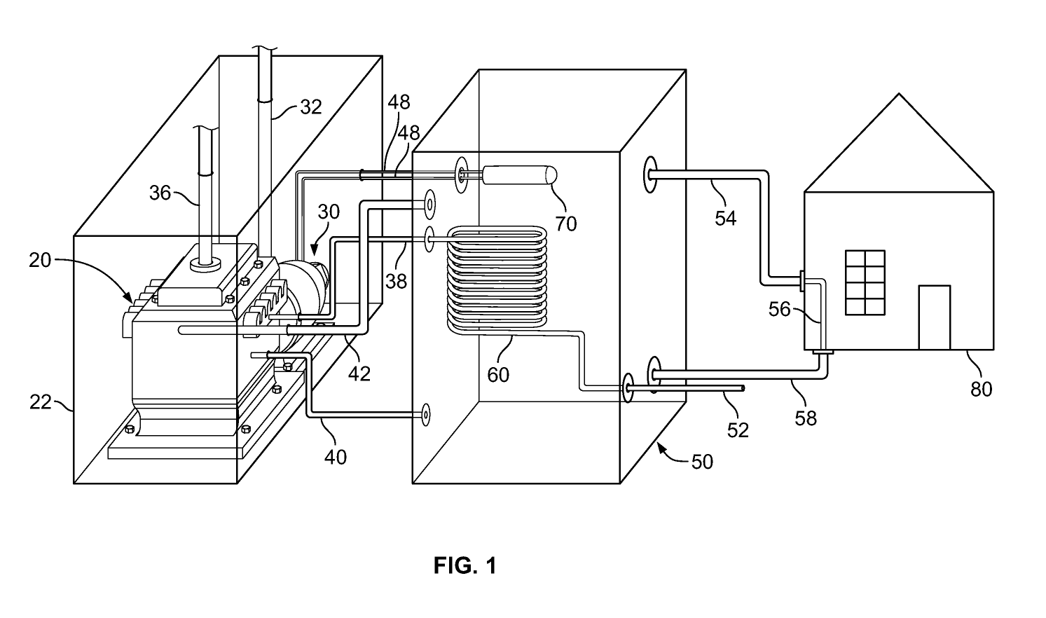

In broad terms, the heating system is designed to maximize the recovery of a fuel's BTU value, as well as its converted kinetic energy, and concentrating them into a common water bath. Referring to FIG. 1, an exemplary embodiment of a heating system 10 is illustrated. Heat from an operating engine 20 is drawn from the engine 20 to a liquid or water tank 50. The heat is transferred by means of liquid, i.e. water and exhaust. In addition, the engine 20 drives a generator 30 which energizes a heating element 70 located in the water tank 50. The combination efficiently heats the water in the water tank 50, such that the heated water can be supplied to heat in a defined space 80, such as, but not limited to, a home. As will be more fully explained, this system 10 achieves an energy efficiency which, heretofore, has not been obtained.

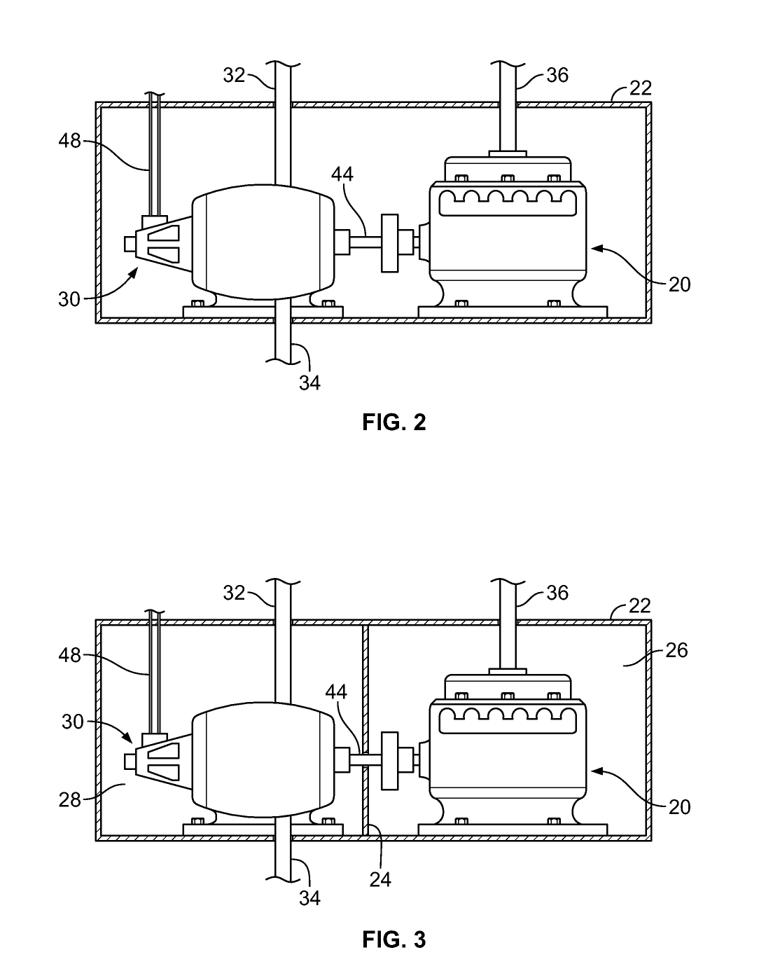

In the exemplary embodiment shown, the engine 20 and generator 30 are housed in an insulated cabinet or housing 22. The cabinet 22 may have a single compartment (FIG. 2) which houses the engine 20 and the generator 30, or the compartment may have a thermal barrier 24 which extends to separate the cabinet into thermally separated compartments 26, 28, with the engine 20 located in compartment 26 and the generator 30 located in compartment 28, as shown in FIG. 3. While the cabinet 22 and compartments 26, 28 are shown, the heating system 10 may be configured in different ways which would eliminate the need for the cabinet 22 and/or the compartments 26, 28.

In this particular embodiment, the cabinet 22 is provided to maintain heat within the structure, thereby enabling the engine 20 to ramp-up to its operating temperature more quickly, which reduces the cycle time of the engine 20 and provides greater efficiency to the system 10, as will be more fully described. However, the air temperature surrounding the engine 20 may be maintained by placing the engine 20 in other controlled areas or by other known means. The cabinet 22 may also be configured to provide sound insulation, thereby minimizing or preventing the sound of the engine 20 from being transmitted to the surrounding environment.

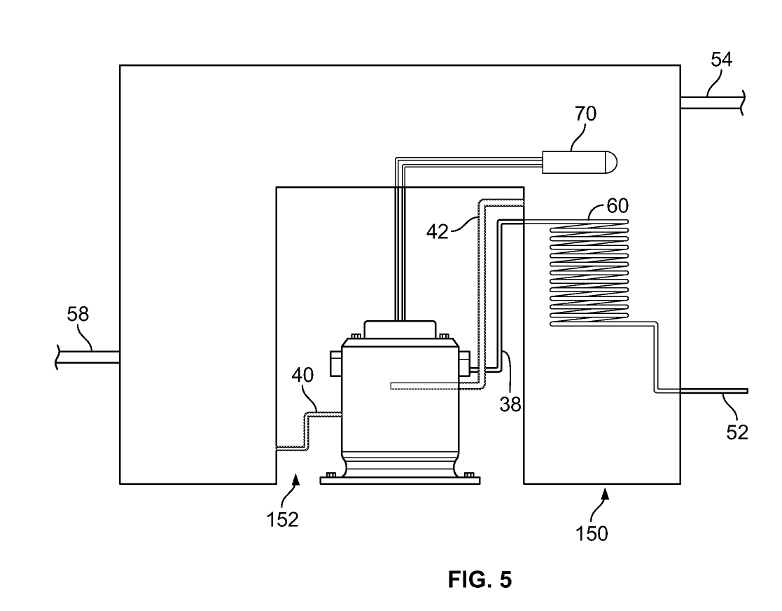

An example of another controlled area is shown in FIG. 5. An upside down U-shaped water tank 150 may be used to surround the engine 20. An opening 152 provided in the tank 150 is dimensioned to allow the engine 20 to be housed therein. This exemplary embodiment eliminates the need for the housing 22, as the water tank 150 which surrounds the opening 152 maintains heat within the structure, thereby enabling the engine 20 to ramp-up to its operating temperature more quickly, which reduces the cycle time of the engine 20 and provides greater efficiency to the system 10. In this embodiment, the generator 30 may be positioned outside of the opening 152 to allow the generator 30 to be air cooled. The engine 20 may be provided on tracks or another type of movable device known in the industry to allow the engine 20 to be easily removed from the opening 152 as needed for repair, etc. The connections of the various conduits to the engine 20 can be made using flexible tubing, quick disconnect members, or other known means to allow for the movement of the engine 20 into and out of the opening 152.

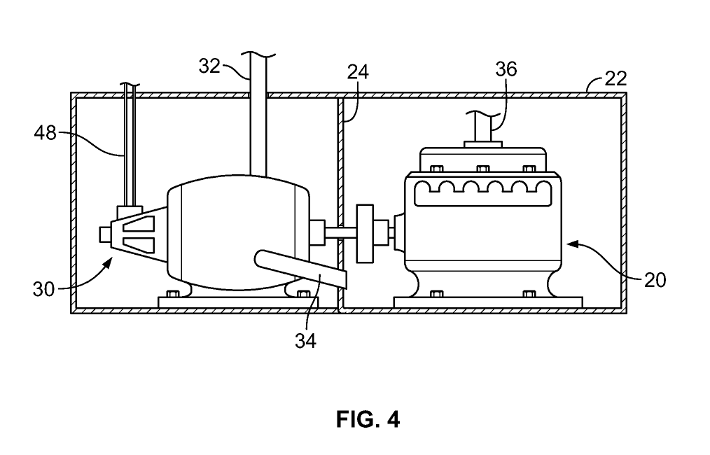

Referring to the exemplary embodiments shown in FIGS. 2 and 3, an transfer system may include an air conduit 32 to supply outside cooling air to generator 30 to maintain the generator 30 at an optimum operating temperature. The conduit 32 directs the air flow to the appropriate location on the generator, as is known in the industry. The air flow is then directed to a plenum 34 which allows the air flow to exit the cabinet 22. This allows the generator 30 to be cooled as required, while allowing the temperature in the cabinet 22 to be optimized for the operation of the engine 20. Alternatively, as shown in FIG. 4, the plenum 34 may be directed engine compartment 26, thereby providing additional heat to the engine compartment, enabling the engine 20 to ramp-up to its operating temperature more quickly, further reducing the cycle time of the engine 20 and providing greater efficiency to the system 10. Depending on the generator, the air conduit 32 and plenum 34 may not be required, as various generators can operate efficiently in an environment in which the intake air is heated.

The air transfer system also includes a conduit 36 to supply outside air to an air intake of the engine 20. Air is supplied through the conduit 36 as heated exhaust air is discharged from the engine 20 and removed from the cabinet 22 through an exhaust discharge system which includes a discharge conduit 38. The discharge conduit 38, as shown in FIG. 1, extends through cabinet 22 and into water tank 50. The appropriate airtight and watertight seals are provided at the interfaces of the discharge conduit 38 with the cabinet 22 and the water tank 50, respectfully. The individual seals are of any type known in the industry which have the required characteristics.

The engine 20 also has a liquid coolant system. As shown in FIG. 1, an engine coolant-in conduit 40 extends from the water tank 50 through the cabinet 22 and to the engine 20. The liquid or water that enters the engine 20 from the first conduit 40 circulates through passages in the engine 20 and exits from the engine through a second or engine coolant-out conduit 42. As the water is circulated through the operating engine 20, heat is transferred from the engine 20 to the water, as is known in the industry. The water that exits the engine 20 through the engine coolant-out conduit 42 is, therefore, at an elevated temperature as compared to the water that enters the engine 20 through the engine coolant-in conduit 40. The engine coolant-out conduit 42 extends from the engine 20 through the cabinet 22 and into the water tank 50. The appropriate airtight and watertight seals are provided at the interfaces of the coolant conduits 40, 42 with the cabinet 22 and the water tank 50, respectfully. The individual seals are of any type known in the industry which have the required characteristics.

The generator 30 is connected to the engine 20 by a shaft 44. As the engine 20 is operated, the shaft 44 will turn the generator 30, causing the generator 30 to rotate and generate electricity. The generator has wires 48 which extend therefrom to the heating element 70. As previously described, in one exemplary embodiment, the thermal barrier 24 provides heat insulation between the compartments 26 and 28. This allows compartment 26 to remain at a relatively high temperature (e.g., approximately 160 degrees Fahrenheit) during operation of the engine 20, while allowing compartment 28 to operate at a much lower temperature (e.g., approximately 100 degrees Fahrenheit). The higher temperature in compartment 26 enhances the efficiency of heat capture and transfer to the water tank 50. The lower temperature in compartment 28 enhances the life of generator 30 while simultaneously decreasing the amount of cooling air needed from the outside to maintain the lower temperature, and thus further increasing the efficiency of the system.

An example of the type of engine and generator that can be used in the system 10 is an Isuzu 15 kW Diesel Generator, Model Num 01215. This engine/generator has a power rating on the order of 28 horsepower. The exact unit and capacity will be selected in accordance with the size of the area to be heated and the area of the country. It is important to note that the capacity required by such an engine and generator is considerably less than conventional residential heating wisdom teaches is necessary for ensuring adequate heat during periods of high thermal demand, such as continued cold weather, etc. However, by using an engine of this size, we are able to operate it with a higher duty cycle than is common in residential heating systems, and thereby considerably improve heating efficiency.

Referring now to the water tank 50, in the exemplary embodiment shown, the engine coolant-in conduit 40 extends from proximate the bottom of the water tank 50. In contrast, the engine coolant-out conduit 42 enters proximate the top of the water tank 50. As hot water rises, this arrangement of the conduits 40, 42 allows the engine coolant-in conduit to draw the coolest water in the water tank 50 into the engine 20. This also allows the hottest water to be deposited near the hot water dispensing pipes, as will be more fully described.

The engine exhaust discharge conduit 38 enters the water tank 50 above the engine coolant-in conduit 40. The discharge conduit 38 is connected to a heat exchanger 60 which is located inside of the water tank 50 and submersed in the water provided therein. The heat exchanger 60 is preferably a conventional coil element in which the heated exhaust gas is carried within the coil element through the liquid to be heated. Such a construction is well known and thus will not be illustrated in detail. However, other heat exchangers, such as known multi-tube elements, can also be used. The heat exchanger 60 is connected to an exhaust conduit 52 which vents or discharges the cooled exhaust gas through a roof, chimney or wall of the structure to the exterior of the installation for discharge into the atmosphere. As the heated exhaust is moved through the heat exchanger 60, condensation may occur in the coil element as the heated exhaust cools. In order to prevent the condensation from entering the engine 20 through the engine exhaust discharge conduit 38, the plane of the exhaust conduit 52 is positioned below the plane of the engine exhaust discharge conduit 38, thereby allowing any condensation to drain through the exhaust conduit 52. Because of the efficiency of the heating system in utilizing the heat generated, the temperature of the exhaust gas is approximately 100 degrees.

A heating element 70 may also be provided in the water tank 50. The heating element 70 is electrically connected to generator 30 by means of the wires 48. The heating element 70 may be any type of heating element which produces heat in response to an electrical input, such as, but not limited to, an electric resistance heater. The heating element 70 is positioned proximate the top of the water tank 50 to provide a supplemental heat source to more quickly heat the water which is to be circulated through heating conduits or hot water dispensing pipes 54 and into the space 80 to be heated.

Provided proximate the top of the water tank 50 is the hot water dispensing pipe 54. The heated water is discharged from the water tank 50 into the hot water dispensing pipe 54 for distribution through the heating pipes 56 in the space 80 to be heated. The hot water dispensing pipe is positioned proximate the top of the water tank to insure that the hottest water in the tank 50 is discharged into the hot water dispensing pipe 54. As the engine coolant-out conduit 42, the exhaust discharge conduit 38 and the heating element 70 are provided proximate the top of the tank, and as hot water rises, the water provided proximate the top of the tank is heated to a predetermined temperature for heating the defined space 80 thereby allowing a discharged heating conduit positioned proximate the top of the tank to draw the heated liquid from the tank and distribute the heated liquid to the defined space 80. A heating pump or the like may be provided to properly distribute the liquid through the defined space 80.

The heating pipes 56 are connected to a water return pipe 58 which is connected to the water tank 50. The water return pipe 58 is positioned proximate the bottom of the water tank 50, as the water which is returned from the heating pipes 56 is cooler than the water dispensed in the hot water dispensing pipe 54, the heat from the water having been dissipated in the residential area to be heated or the like. The size of the tank 50 can vary according to the size of the area to be heated and the environmental conditions related to the geographic location of the space 80. As an example, a 400 gallon water tank can heat a 3700 square foot new home in the northeastern portion of the United States for 10 to 12 hours.

The heating system 10 operates in response to a heat demand element such as a thermostat. When the thermostat calls for heat, the water is drawn from the tank 50. Once the water temperature falls below a predetermined temperature, the engine 20 is started to again heat the water. The heat from the operation of the engine is transferred to the water tank 50 by the exhaust transfer system and the liquid coolant system as described above. At the same time, generator 30, which is connected to engine 20, is rotated by the engine 20 to thereby generate electricity. The electricity so generated is used to energize the electric heating element 70. The combination of the exhaust transfer system, the liquid coolant system and the electric heating element allows the water in the water tank 50 to be heated. Upon reaching a predetermined temperature, the heated water is discharged through the dispensing pipe 54 to the heating pipes 56, thereby heating the desired area.

The efficiency of the type of heating system referenced herein, of which the embodiments shown and described are but exemplary examples, is significantly increased compared to known heating systems. As the engine 20 is run, the heat is drawn from the engine 20 by the exhaust transfer system and the liquid coolant system. In addition, the engine 20 drives the generator 30, which in turn powers the electric heating element 70. Therefore, for every unit of fuel that is consumed by the engine 20, the efficiency rating is greatly enhanced, thereby reducing the amount of fuel consumed to heat the space. As an example, using the Annual Fuel Utilization Efficiency of the Energy Star rating system previously described, the engine 20 would have an Energy Star rating of approximately 127 compared to previous “high efficiency” conventional propane or gas furnaces of 97 and conventional oil-fired furnaces of 84.

The time to heat the water in the water tank 50 is also reduced compared to conventional systems. As the water is heated by the combination of the exhaust transfer system, the liquid coolant system and the electric heating element, the amount of time it takes to raise the water temperature to the predetermined temperature is reduced. As the exhaust transfer system, the liquid coolant system and the electric heating element are all heating the water simultaneously, the water in the water tank 50 is heated quickly, thereby allowing the heated water to be discharged more quickly. This allows the heat to be dissipated to the desired area promptly after being requested by the thermostat.

As the time to heat the water is reduced, the amount of time that the engine is run is also reduced. This reduces wear on the engine, generator and other components in the system. Reduced run time also reduces the cost of fuel required to run the engine. In addition, by decreasing the amount of fuel, the efficiency of the system is increased.

From the foregoing it will be seen that an improved heating system is provided. The system is highly efficient and is suited to residential, commercial and industrial applications, although other applications are practical. This unique heating system enables use of a prime heat generator of comparatively smaller capacity than commonly believed feasible, while providing sufficient capability to meet even extreme needs. The use of the system is economical and energy-efficient. In addition, the use of a generator 30 allows the system to be used at times of a power outage.

While the written description has referred to an exemplary embodiment, it will be understood by those skilled in the art that various changes and modifications may be made and equivalents may be substituted for elements thereof without departing from the patentable scope as defined by the claims. As an example, the generator may be replaced or supplemented with other components which could generate additional heat through friction, with the heat being supplied to the water tank. Therefore, it is intended that the patentable scope not be limited to the particular embodiments disclosed as the best mode contemplated, but rather other embodiments are intended to be within the scope of the claims if they have structural elements that do not differ from the literal language of the claims, or if they include equivalent structural elements with insubstantial differences from the literal language of the claims.

1. A heating system for heating a defined space, the heating system comprising:
an engine;
a tank for heating liquid enclosed in the heating system;
a liquid coolant system, the liquid coolant system having conduits which extend between the engine and the tank, a first respective conduit supplying coolant liquid from the tank to the engine, a second respective conduit supplying liquid which has been drawn through the engine and heated to the tank;
an exhaust transfer system, the exhaust transfer system having an exhaust conduit which extends from the engine to the tank, the exhaust conduit conducts heated exhaust from the engine to the tank, the exhaust conduit connected to a heat exchanger to facilitate an exchange of heat from the heated exhaust to the liquid in the tank;
a heating element located in the tank, the heating element providing a supplemental heat source;
whereby the liquid coolant system and the exhaust transfer system cooperate to heat the liquid in the tank quickly, thereby minimizing run time of the engine and increasing the efficiency of the heating system.

2. The heating system recited in claim 1, wherein a generator is mechanically attached to the engine, the generator being rotated to produce an electrical current when the engine is engaged, the electrical current being used to power a heating element located in the tank, the heating element providing a supplemental heat source.

3. The heating system recited in claim 2, wherein the heating element is an electric resistance heater.

4. The heating system recited in claim 1, wherein the engine is housed in an insulated cabinet to maintain heat within the cabinet, thereby enabling the engine to ramp-up to its operating temperature with high efficiency.

5. The heating system recited in claim 2, wherein the engine and the generator are housed in an insulated cabinet to maintain heat within the cabinet, the cabinet has a thermal barrier which extends to separate the cabinet into thermally separated compartments, with the engine located in a first compartment and the generator located in second compartment.

6. The heating system recited in claim 1, wherein the engine is a diesel engine.

7. The heating system recited in claim 1, wherein the second respective conduit, the exhaust conduit and the heating element are provided proximate the top of the tank, whereby the liquid provided proximate the top of the tank is heated to a predetermined temperature for heating the defined space thereby allowing a discharged heating conduit positioned proximate the top of the tank to draw the heated liquid from the tank and distribute the heated liquid to the defined space.

8. A heating system for heating a defined space, the heating system comprising:
an engine;
a generator mechanically attached to the engine, the generator being rotated to produce an electrical current when the engine is engaged;
a tank for heating liquid enclosed in the heating system;
a liquid coolant system, the liquid coolant system having conduits which extend between the engine and the tank, a first respective conduit supplying coolant liquid from the tank to the engine, a second respective conduit supplying liquid which has been drawn through the engine and heated to the tank;
an exhaust transfer system, the exhaust transfer system having an exhaust conduit which extends from the engine to the tank, the exhaust conduit conducts heated exhaust from the engine to the tank, the exhaust conduit connected to a heat exchanger to facilitate an exchange of heat from the heated exhaust to the liquid in the tank;
a heating element located in the tank, the heating element receiving the electrical current from the generator and converting the electrical current to a supplemental heat source for the liquid;
heating conduits extending from the tank, the heating conduits extending between the tank and the space to be heated;
whereby the liquid coolant system, the exhaust transfer system and the heating element are all driven from the operation of the engine, thereby increasing the efficiency of the heating system.

9. The heating system recited in claim 8, wherein the heating element is an electric resistance heater.

10. The heating system recited in claim 8, wherein the engine is housed in an insulated cabinet to maintain heat within the cabinet, thereby enabling the engine to ramp-up to its operating temperature with high efficiency.

11. The heating system recited in claim 8, wherein the engine and the generator are housed in an insulated cabinet to maintain heat within the cabinet, the cabinet has a thermal barrier which extends to separate the cabinet into thermally separated compartments, with the engine located in a first compartment and the generator located in second compartment.

12. The heating system recited in claim 8, wherein the engine is a diesel engine.

13. The heating system recited in claim 8, wherein the second respective conduit, the exhaust conduit and the heating element are provided proximate the top of the tank, whereby the liquid provided proximate the top of the tank is heated to a predetermined temperature for heating the defined space thereby allowing a discharged heating conduit positioned proximate the top of the tank to draw the heated liquid from the tank and distribute the heated liquid to the defined space.

14. A method for heating a defined space, the method comprising:
engaging an engine;
generating an electrical current when the engine is engaged;
cooling the engine with a liquid coolant system, the liquid coolant system having conduits which extend between the engine and a tank, a first respective conduit supplying coolant liquid from the tank to the engine;
heating the coolant liquid in the engine and returning the heated coolant liquid through a second respective conduit to the tank to heat the liquid in the tank;
transferring heated exhaust through an exhaust conduit which extends from the engine to the tank to heat the liquid in the tank;
activating a heating element located in the tank by using the electrical current generated, the heating element providing supplemental heat to heat the liquid in the tank;
drawing the heated liquid through a heating conduit to heat the defined space;
whereby the liquid in the tank is heated in an energy efficient manner.

15. The method recited in claim 14 comprising maintaining air surrounding the engine at an elevated temperature when the engine is not engaged.

16. The method recited in claim 14 comprising suppressing the sound of the engine when the engine is engaged.

17. The method recited in claim 14 comprising thermally insulating the engine from the generator.

18. The method recited in claim 14 comprising positioning the second respective conduit, the exhaust conduit and the heating element proximate the top of the tank, whereby the liquid provided proximate the top of the tank is heated to a predetermined temperature for heating the defined space and positioning the heating conduit proximate the top of the tank to draw the heated liquid from the tank and distribute the heated liquid to the defined space.

19. The method recited in claim 14, wherein the heating element is an electric resistance heater.

20. The heating system recited in claim 14, wherein the engine is a diesel engine.
